(19) United States
(12) Patent Application Publication
(10) Pub. No.: US 2008/0056813 A1
(43) Pub. Date: Mar. 6, 2008

(54) Motor Vehicle Actuating Drive With An Axial Play Compensation Element Disposed Between The Transmission Shaft And The Motor Shaft

(76) Inventor: Gerald Viernekes, Hassfurt (DE)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 11/572,531

(22) PCT Filed: Jun. 17, 2005
(86) PCT No.: PCT/EP05/52813

§ 371 Date: Jan. 23, 2007

(30) Foreign Application Priority Data
Jul. 23, 2004 (EP) 04017536.6

(51) Int. Cl. F16D 1/027; F16D 39/00

(52) U.S. Cl. 403/311; 60/327

(57) ABSTRACT

A motor vehicle actuating drive has a transmission unit provided with a gear shaft (2) and a motor unit having a motor shaft (4). The gear shaft (2) and the motor shaft (4) are aligned in an axial direction. An axial play compensation element (6) is provided between the gear shaft (2) and the motor shaft (4), whereby said axial play compensation element is in the form of a hardened plastic material.

### CROSS-REFERENCE TO RELATED APPLICATIONS

This application is a U.S. national stage application of International Application No. PCT/EP2005/052813 filed Jun. 17, 2005, which designates the United States of America, and claims priority to European application number 04017536.6 filed Jul. 23, 2004, the contents of which are hereby incorporated by reference in their entirety.

### TECHNICAL FIELD

The invention relates to a motor vehicle actuating drive with an axial play compensation element disposed between the transmission shaft and the motor shaft

### BACKGROUND

Motor vehicle actuating drives, for example window lifting drives or sliding roof actuating drives, are already known. They have a motor unit and a transmission unit. The transmission unit has a worm wheel and a transmission shaft configured as a worm shaft. The motor unit comprises an electric motor disposed in a motor housing, said electric motor being provided with a motor shaft and a rotor core attached thereto and containing a number of blades. The transmission shaft of known motor vehicle actuating drives is milled directly onto the motor shaft. Axial play compensation elements are provided to compensate for manufacture-related tolerances, being positioned on the end region of the transmission shaft facing away from the motor shaft between the transmission shaft and the transmission housing and/or on the end region of the motor shaft facing away from the transmission shaft between the motor shaft and the motor housing. However for manufacture-related reasons such axial play compensation elements cannot compensate fully for manufacturing tolerances. There is always a residual play of up to 0.2 mm.

An electric system is known from EP 1 270 368 A2, having an electric motor with a motor shaft and a transmission with a transmission shaft. In the transition region between the motor shaft and the transmission shaft an axial play compensation element is provided in the form of a spring. In the transition region between the motor shaft and the transmission shaft a connecting element (joint) is also provided, coupling the motor shaft to the transmission shaft for the purpose of transferring torque.

### SUMMARY

The object of the invention is to specify a motor vehicle actuating drive, which improves the transfer of torque from the motor shaft to the transmission shaft.

A motor vehicle actuating drive may comprise a transmission unit having a transmission shaft and a motor unit having a motor shaft connected with the transmission unit rotatable and axially aligned, and an axial play compensation element which is inserted into an axial space in the transition region between the motor shaft and the transmission shaft and subsequently hardened

### BRIEF DESCRIPTION OF THE DRAWINGS

Further advantageous characteristics of the invention will emerge from the exemplary description of said invention based on the figures, in which:

FIG. 1 shows a longitudinal section through part of a motor vehicle actuating drive according to an embodiment,

FIG. 2 shows a schematic view of a first alternative embodiment of a motor vehicle actuating drive and

FIG. 3 shows a schematic view of a second alternative embodiment of a motor vehicle actuating drive.

### DETAILED DESCRIPTION

According to an embodiment, the use of a subsequently hardening plastic mass as the axial play compensation element improves the coupling between the motor shaft and the transmission shaft, once the plastic mass has been allowed to harden. This improves the transfer of torque from the motor shaft to the transmission shaft compared with the prior art.

According to an embodiment, the transmission shaft is provided with an opening in its end region facing the motor shaft, into which opening an end region of the motor shaft projects. This has the advantage that the region, into which plastic mass is to be inserted when assembling the actuating drive, is defined, thereby ensuring that the plastic mass does not escape into other parts of the actuating drive.

A motor vehicle actuating drive with the features mentioned above can be configured in a further embodiment of the dimensioning such that the opening provided in the end region of the transmission shaft in the radial direction is greater than the diameter of the section of the motor shaft projecting into the opening. This has the advantage that the dimensioning of the opening ensures that on the one hand plastic mass can be inserted easily into the transition region between the motor shaft and the transmission shaft and on the other hand that plastic mass can also be inserted into the region between the outer periphery of the motor shaft and the inner periphery of the transmission shaft, thereby further improving the coupling between the motor shaft and the transmission shaft once the plastic mass has been allowed to harden.

In a further embodiment of the motor vehicle actuating drive, at least one notch starting from the end of the shaft is provided on the periphery of the region of the motor shaft projecting into the transmission shaft. Starting from the end of the shaft the notch can run both straight in the axial direction and in a spiral manner on the periphery of the relevant shaft region. This has the advantage that plastic mass can be inserted easily into the transition region between the motor shaft and the transmission shaft. On the other hand the plastic mass inserted in the region of the one or more notches also improves the coupling between the motor shaft and the transmission shaft further when it has been allowed to harden.

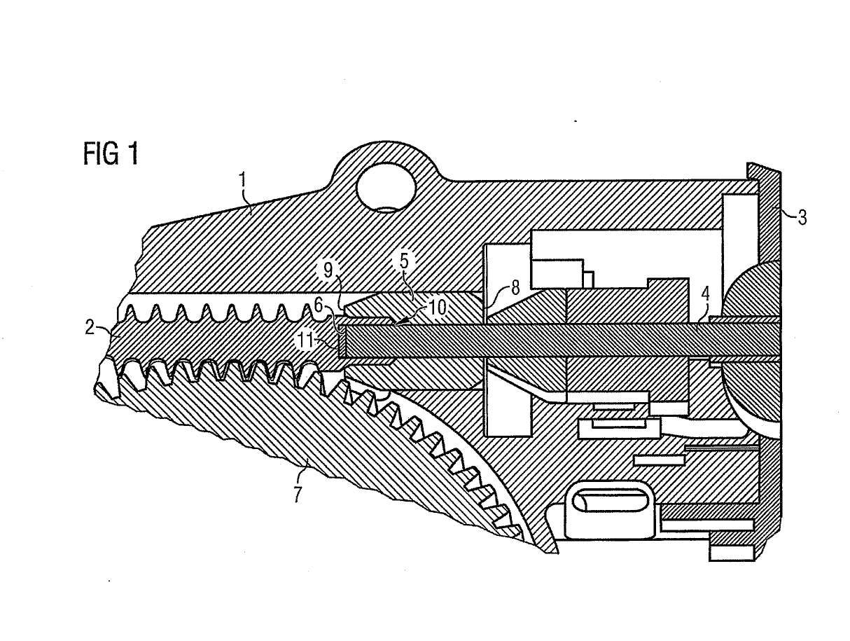

FIG. 1 shows a longitudinal section through part of a motor vehicle actuating drive according to an embodiment. The actuating drive shown has a transmission housing 1 and a motor housing 3 flanged onto this. A worm wheel 7 and a transmission shaft 2 configured as a worm shaft are for example provided in the transmission housing 1. A motor shaft 4 is provided in the motor housing 3, projecting into the transmission housing 1 in an axial direction.

The left-hand end of the motor shaft 4 and the right-hand end of the transmission shaft 2 are supported in a common bearing 5. This is positioned in the transmission housing 1.

The end region of the transmission shaft 2 has a cylindrical opening 10, into which the end region of the motor shaft 4 projects in an axial direction. An axial play compensation element 6 is provided between the end region of the motor shaft 4 and the base 11 of the cylindrical opening 10 of the transmission shaft 2, to compensate for any manufacturing inaccuracies of the transmission shaft 2 and/or motor shaft 4.

This axial play compensation element 6 is a subsequently hardening plastic mass, which is inserted into the cylindrical opening 10 of the transmission shaft 2 when the actuating drive is assembled and after being allowed to harden not only compensates for the manufacture-related axial play but also reinforces the coupling between the motor shaft 4 and the transmission shaft 2. This improves the transfer of torque from the motor shaft 4 to the transmission shaft 2. It also prevents or at least significantly reduces the occurrence of shift noises.

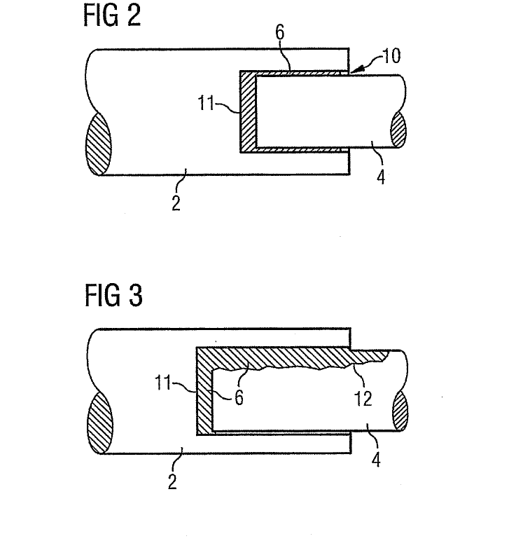

FIG. 2 shows a schematic view of a first alternative embodiment of a motor vehicle actuating drive.

According to this alternative embodiment the opening 10 provided in the end region of the transmission shaft 2 in the radial direction is greater than the diameter of the motor shaft 4. This has the advantage that plastic mass can be inserted easily through the gap thereby formed into the transition region between the motor shaft 4 and the transmission shaft 2. This means that it is possible to insert the plastic mass into the opening 10 of the transmission shaft after the motor shaft has been inserted. A further option is for the excess plastic mass inserted before the assembly process to be compressed into the transition region when the motor shaft 4 and transmission shaft 2 are brought together during assembly. This also has the advantage that the quantity of plastic mass can be tailored to the size of the axial play present in each individual instance. If the axial play is small, only comparatively little plastic mass is inserted. If the axial play is large however, a comparatively large amount of plastic mass is inserted. A further advantage of the embodiment shown in FIG. 2 is that the lateral region between the outer periphery of the motor shaft 4 and the internal diameter of the opening 10 is filled with plastic mass 6. When this plastic mass is allowed to harden, the coupling between the motor shaft 4 and transmission shaft 2 and therefore also the transfer of torque from the motor shaft to the transmission shaft improves compared with the embodiment shown in FIG. 1.

FIG. 3 shows a schematic view of a second alternative embodiment of a motor vehicle actuating drive. According to this second alternative embodiment the end region 4 of the motor shaft is provided with a notch 12 starting from the end of the shaft and disposed in an axial alignment. This notch causes a gap to occur, through which plastic mass can be inserted easily into the transition region between the motor shaft 4 and the transmission shaft 2. This means that it is possible to insert the plastic mass into the opening 10 of the transmission shaft after the motor shaft has been inserted or to compress excess plastic mass inserted beforehand into the notch during the assembly process. This also has the advantage that the quantity of plastic mass can be tailored to the size of the axial play present in each individual instance. If the axial play is small, only comparatively little plastic mass is inserted. If the axial play is large however, a comparatively large amount of plastic mass is inserted. A further advantage of the embodiment shown in FIG. 3 is that part of the lateral region between the outer periphery of the motor shaft 4 and the internal diameter of the opening 10 is also filled with plastic mass. When this plastic mass is allowed to harden, the coupling between the motor shaft 4 and the transmission shaft 2 and therefore also the transfer of torque from the motor shaft to the transmission shaft improves compared with the embodiment shown in FIG. 1.

A number of notches distributed over the periphery of the motor shaft can also be provided to further enhance this effect.

What is claimed is:

1. A motor vehicle actuating drive comprising:
a transmission unit having a transmission shaft and
a motor unit having a motor shaft, wherein the transmission shaft and the motor shaft are connected such that they rotate together and are aligned axially, and
an axial play compensation element between the transmission shaft and the motor shaft, wherein the axial play compensation element is a plastic, subsequently hardening mass inserted into an axial space in the transition region between the motor shaft and the transmission shaft.

2. The motor vehicle actuating drive according to claim 1, wherein the transmission shaft is provided with an opening in its end region facing the motor shaft, into which opening an end region of the motor shaft projects.

3. The motor vehicle actuating drive according to claim 2, wherein the opening provided in the end region of the transmission shaft in the radial direction is greater than the diameter of the motor shaft.

4. The motor vehicle actuating drive according to claim 2, wherein the motor shaft is provided with at least one notch on its outer periphery in its region projecting into the transmission shaft.

5. A motor vehicle actuating drive comprising:
a transmission unit having a transmission shaft and
a motor unit having a motor shaft connected with the transmission unit rotatable and axially aligned, and
an axial play compensation element which is inserted into an axial space in the transition region between the motor shaft and the transmission shaft and subsequently hardened.

6. The motor vehicle actuating drive according to claim 5, wherein the transmission shaft is provided with an opening in its end region facing the motor shaft, into which opening an end region of the motor shaft projects.

7. The motor vehicle actuating drive according to claim 6, wherein the opening provided in the end region of the transmission shaft in the radial direction is greater than the diameter of the motor shaft.

8. The motor vehicle actuating drive according to claim 6, wherein the motor shaft is provided with at least one notch on its outer periphery in its region projecting into the transmission shaft.

9. A method for compensating manufacturing deviations in a motor vehicle actuating drive comprising the steps of:
axially aligning a transmission unit having a transmission shaft and a motor unit having a motor shaft, and
inserting an axial play compensation element into an axial space in the transition region between the motor shaft and the transmission shaft;
hardening the axial compensation element.

10. The method according to claim 9, wherein the axial play compensation element is an insertable plastic mass.

11. The method according to claim 9, wherein the transmission shaft is provided with an opening in its end region facing the motor shaft, into which opening an end region of the motor shaft projects.

12. The method according to claim 11, wherein the axial play compensation element is a plastic mass inserted in said opening.

13. The method according to claim 11, wherein the opening provided in the end region of the transmission shaft in the radial direction is greater than the diameter of the motor shaft.

14. The method according to claim 11, wherein the motor shaft is provided with at least one notch on its outer periphery in its region projecting into the transmission shaft.
